(19) United States
(12) Patent Application Publication
(10) Pub. No.: US 2013/0193690 A1
(43) Pub. Date: Aug. 1, 2013

(54) METHOD FOR PRODUCING HYDROELECTRIC POWER

(71) Applicants: Dmitri Victorovich Mironov, Tyumen (RU); Victor Vladimirovich Mironov, Tyumen (RU)

(72) Inventors: Dmitri Victorovich Mironov, Tyumen (RU); Victor Vladimirovich Mironov, Tyumen (RU)

(21) Appl. No.: 13/575,309

(22) PCT Filed: Jun. 1, 2010
(86) PCT No.: PCT/RU2010/000218

§ 371 Date: Aug. 16, 2012

(30) Foreign Application Priority Data
Feb. 16, 2010 (RU) 2010105597

(51) Int. Cl. F03B 13/10

(52) U.S. Cl. CPC F03B 13/10
USPC 290/54

(57) ABSTRACT

The invention relates to hydropower, specifically to methods for using the water resources of lowland rivers for generating electrical energy. The method for producing hydroelectric power comprises setting coils of an insulated current-conducting conductor in motion relative to magnets under the action of the energy from a flow of water in a water conduit and tapping off the voltage from the coils. The pressure of the water in the water conduit is changed in a pulsed mode with the aid of a periodically initiated hydraulic impact. Radial pulsation of part of the walls of the water conduit is induced. The coils of insulated conductor which are mounted on the pulsating parts of the walls of the water conduit and the magnets mounted on the motionless parts of the walls of the water conduit are set in reciprocal radial motion with respect to one another. Electrical energy is generated in the coils of the insulated current-conducting conductor.

The invention relates to hydraulic power, specifically, methods of using water resources for generating of electric power.

Practically all methods for producing hydroelectric power involve sending a flow of water along a conduit to a turbine, consisting of blades attached to a rotor, and a stator winding. The turning rotor leads to a change in the magnetic field in the stator winding, which is made from an insulated, electrically conducting material, inducing electric power in it. For example, see Russian Federation patent No. 2157870, E02B 9/00.

The closest to the proposed technical solution (prototype) in having the largest number of similar features and in the result accomplished by it is the method involving the supplying of water under the pressure head of a hydraulic station to a machine set [Children's Encyclopedia, vol. 5, Technology and industry, M: Prosveshcheniye, 1965, pp. 171-174]. The turbine of the set causes the rotor of a hydrogenerator to turn, on which are mounted the poles of powerful electromagnets, whose field acts on a winding installed in the stator and made of insulated conductors, thereby generating hydroelectric power.

The shortcoming of the prototype is that the energy of the moving water with the use of traditional hydraulic turbines is tapped from the cross section of the water flow of the conduit where the turbine is installed, and the power of the flow in cross section depends on the pressure head and the water flow rate in it, which in turn are limited by the height of the dam and the hydraulic resistances present in the conduit. The construction of high dams in order to increase the mechanical power that can be derived from the water flow at the site of installation of the turbine is expensive and, furthermore, inflicts sizeable ecological harm on the adjacent territories.

The technical problem of the invention is to create a sufficiently simple method of producing a considerable quantity of hydroelectric power with minimal ecological harm to adjacent territories.

According to the invention, the technical problem is solved as follows. The method for producing hydroelectric power, involving the setting of magnets and windings of an insulated, current-conducting conductor in motion relative to each other under the action of the energy of a water flow supplied along a water conduit, and picking off voltage from the windings, is characterized in that the water pressure in the conduit is changed to a pulsating mode, inducing a pulsation of a portion of the walls of the conduit by periodically initiated hydraulic impact, setting the magnets which are mounted on the nonmoving parts of the walls of the conduit and the windings of the insulated conductor that are mounted on the pulsating parts of the walls of the conduit in a radial reciprocating motion relative to each other, so that the field of the magnets acts on the windings.

In the proposed method, the kinetic energy of the entire volume of water moving in the conduit with its initial velocity (prior to initiating the hydraulic impact in the water conduit) is transformed at first, upon closing the cross section of the water conduit, into the potential energy of the elastic deformation of the water and of the walls of the water conduit, under the action of which mechanical work is performed in the relative radial displacement of the magnets and the windings of the insulated conductor that are mounted uniformly along the length of the water conduit at its nonmoving and moving parts, respectively, resulting in the generating of electric power in the windings of the insulated conductor.

The method for producing hydraulic power is realized as follows. Hydraulic units are constructed in the form of pipelines (water conduits), a portion of whose walls are capable of radial displacement under the action of the changing water pressure in the pipelines, which is caused by periodically initiated hydraulic impact. High-energy magnets with magnetic circuits are attached to the nonmoving parts of the walls of the pipelines; annular windings of insulated conductor, which are attached to moving parts of the walls of the pipelines (water conduits) are installed in the air gaps of the magnetic circuits . A hydraulic impact is created in the pipelines with the use of hydraulic rams [Hydraulics. N. N. Kremenetskiy, D. V. Shterenlikht, V. M. Alyshev, L. V. Yakovleva, Moscow: Energiya, 1973, pp. 215-217]. The hydraulic impact initiated by the hydraulic ram results in pressure fluctuations in the pipeline and radial displacements of the annular windings relative to the magnets with the magnetic circuits, thereby inducing electromotive force in the annular windings.

Consider the following example: the initial velocity of movement of the water in a steel diversion pipeline of a hydroelectric station with internal diameter of 1.4 m is 5 m/s, and the height difference between the beginning and end of the diversion pipeline is 5 m. Of the 5 meters, 1 meter goes to the height of the dam needed to maintain the parameters of movement of the water in the diversion pipeline constant over time or to regulate these parameters. The length of the diversion pipeline is 138 m. The flow rate factor of the pipeline system for the given parameters is equal to 0.5. The flow rate factor allows for the loss of energy (pressure head) due to hydraulic resistances of the pipeline, especially due to friction along the length as the water moves in the pipeline and due to local resistances occurring in the pipeline system (entrance to the pipeline, bending of the pipeline, and so forth). The diversion pipeline at the same time constitutes a hydraulic unit for providing a new method for producing hydroelectric power. The area of the moving part of the walls of the pipeline attached to windings of insulated conductor per unit of length of the pipeline is 1.54 m².

Upon abrupt closing of the cross section at the end of the pipeline by the valve of the known water ram layout, a direct hydraulic impact is produced in it, with a rated impact pressure of 0.69 MPa. The hydraulic impact travels from the closed cross section of the pipeline to its beginning at the speed of propagation of the impact wave. In the present example, this is 138 m/s, according to calculations, producing consecutive radial displacement of the movable parts of the walls of the pipeline, which are attached to the windings of the insulated conductor, by 5 cm relative to the magnets mounted on the nonmoving parts of the walls of the pipeline. The mechanical work performed by the impact pressure during one second with consecutive radial displacement of all moving parts of the walls of the pipeline over a length of 138 m constitutes the mechanical power, which amounts to 2.6 MW, according to calculations. The mechanical work performed in the first second after initiation of the hydraulic impact with minimal energy losses is practically equal to the kinetic energy of the mass of water moving in the pipeline of given length at the initial velocity. An interruption in the work of the hydraulic unit then occurs. The interruption is necessary to initiate a new hydraulic impact in the pipeline by means of the known hydraulic ram layout, and the process repeats. For a continual tapping of the aforementioned mechanical power, it is necessary to have several identical devices working with a time shift.

For comparison, in the construction of a traditional hydroelectric station, including a diversion pipeline of analogous length, at the end of which a hydraulic turbine is installed with a rotary-type electric generator, given the same height difference of 5 m, where 1 m goes to the height of the dam, and a similar flow rate factor of the pipeline system characterizing the energy losses during the movement of the water in the diversion pipeline, the effective pressure head upstream from the turbine is no more than 1.9 m. The mechanical power which can be tapped continually over time does not exceed 0.15 MW, which is 17.3 times less than the mechanical power that can be tapped with the use of the energy of hydraulic impact for four identical hydraulic units working with a time shift. The construction of four diversion pipelines with hydraulic turbines at their ends will increase the overall power by four times, but still will not enable the tapping of the aforementioned mechanical power of 2.6 MW. Furthermore, this variant will lead to a fourfold increase in the water discharge used for the generation of electricity, since hydraulic turbines run continuously. If turbines are installed in the water flow immediately after the dam without a diversion pipeline, then the mechanical power which can be tapped from a dam height of 1 m in the present example will be even less, since the pressure head in front of the turbine in this case will be lower than when using a diversion.

The use of the proposed technical solution as compared to all known means of similar purpose enables the production of a substantially larger amount of hydroelectric power without the erection of high-head, massive dams and, consequently, without causing substantial ecological harm to the adjacent territories.

1. A method for producing hydroelectric power, involving the setting of magnets and windings of an insulated, current-conducting conductor in motion relative to each other under the action of the energy of a water flow supplied along a water conduit, and picking off voltage from the windings, characterized in that the water pressure in the conduit is changed to a pulsating mode by periodically initiated hydraulic impact, inducing a radial pulsation of a portion of the walls of the conduit and setting the windings of the insulated conductor which are mounted on the pulsating parts of the walls of the conduit and the magnets which are mounted on nonmoving parts of the walls of the water conduit in a radial reciprocating motion relative to each other, generating electric power in the windings of the insulated current-conducting conductor.
